(19) United States
(12) Patent Application Publication
(10) Pub. No.: US 2012/0107762 A1
(43) Pub. Date: May 3, 2012

(54) Method And System For Operating A Medical, In Particular A Dental, Handpiece

(75) Inventors: Johannes Sauter, Mittelbuch (DE); Hans Heckenberger, Assmannshardt (DE); Bernd Gugel, Ulm (DE)

(73) Assignee: KALTENBACH & VOIGT GMBH, Biberach (DE)

(21) Appl. No.: 13/381,815

(22) PCT Filed: Jul. 1, 2010
(86) PCT No.: PCT/EP2010/059365

§ 371 Date: Jan. 17, 2012

(30) Foreign Application Priority Data
Jul. 1, 2009 (DE) 10 2009 031 383.4

(51) Int. Cl. A61C 1/08

(52) U.S. Cl. 433/27; 433/114

(57) ABSTRACT

A method and corresponding system for operating a dental handpiece, wherein the handpiece comprises a motor for driving a tool. the method comprises (a) sequentially capturing values of a physical parameter, which—at least approximately—represent the power or energy fed to the motor, (b) forming an integration value by integrating the values captured in (a), and (c) automatically reducing a power or energy fed to the motor if the integration value formed in (b) exceeds an upper threshold value. The integration value formed in (b) represents a measure of the power integrated over time and can thus be used at least approximately as a measure of the temperature of the instrument. The automatic reduction in the power or energy fed to the motor performed in (c) can therefore effectively act against a further increase in temperature or allow cooling if the temperature of the instrument exceeds an upper threshold value. In this manner, the risk of damage due to excessive temperature of the instrument can be effectively reduced.

The invention relates to a method and to a system for operating a medical, in particular dental, handpiece which has a motor for driving a tool.

The medical handpiece may be, for example, a medical surgical instrument. If the handpiece is a dental handpiece, it may be, for example, a dental instrument which is made up of two parts, with a first part having a motor and a second part having an angle piece. The dental handpiece may also be a single-piece dental instrument in which the motor is integrated in the rest of the handpiece.

In the text which follows, the corresponding handpiece is also referred to as an instrument for the sake of simplicity.

When working with a medical, in particular dental, handpiece of this kind, the problem generally arises of the instrument possibly becoming so hot when the motor is running that this may cause damage, in particular if the instrument is defective or not well-maintained. Therefore, there is a risk, in particular, of burning. For example, a corresponding instrument can damage the soft tissue or the mucous membrane which is in the vicinity of the correspondingly heated instrument. For example, in the case of a dental handpiece with a head region on which the tool is arranged, there is a risk of the head region being particularly intensely heated on account of the bearing which is located therein. A neck region of the instruments which adjoins the head region, for example in a perpendicular manner, also generally has bearing elements, and therefore there is a particular risk of this region being heated. During a dental treatment, this head and neck region is usually located in the mouth area of a patient and therefore in the vicinity of the soft tissue and the mucous membrane, and therefore these are correspondingly at risk of damage.

The invention is based on the object of specifying a method and a system for operating a dental handpiece of this kind, wherein the risk of damage due to an excessively high temperature of the instrument is reduced or virtually precluded.

According to the invention, this object is achieved by the subjects cited in the independent claims. Particular embodiments of the invention are specified in the dependent claims.

The invention provides a method for operating a medical, in particular dental, handpiece, with the handpiece having a motor for driving a tool. The method comprises the following steps: (a) successive detection of values of a physical variable which represents—at least approximately—the power or energy which is supplied to the motor, (b) formation of an integration value by integrating the values which are detected in step (a), and (c) automatic reduction of a power or energy which is supplied to the motor, if the integration value which is formed in step (b) exceeds an upper threshold value.

The integration value which is formed in step (b) is a measure of the power integrated with respect to time and can therefore be regarded at least approximately as a measure of the temperature of the instrument. Therefore, the automatic reduction, which is carried out in step (c), in the power or energy which is supplied to the motor effectively counteracts a further increase in the temperature of the instrument or allows a reduction of the temperature of the instrument when the integrated power exceeds an upper threshold value. The risk of damage due to an excessively high temperature in the instrument, in particular if there is a defect in the instrument, can be effectively reduced in this way.

The physical variable is advantageously the power or energy which is supplied to the motor. A direct measure of the power or energy which is supplied to the motor is utilized in this way; a particularly high level of accuracy of the method can be achieved as a result.

A visual and/or audible signal is advantageously also generated in step (c). In this way, the user of the handpiece can be informed of the automatic reduction, which takes place in step (c), in the power or energy which is supplied to the motor.

Integration is advantageously performed over an integration period in step (b), with the beginning of the integration period being defined as a function of the change, with respect to time, in the values which are detected in step (a). For example, provision may advantageously be made for the integration period to begin when one of the values detected in step (a) is lower than a base threshold value (S₁) and the value that was detected immediately prior was higher than the base threshold value (S₁), or when one of the values detected in step (a) is lower than the base threshold value (S₁) and the value that is detected immediately after is higher than the base threshold value (S₁).

The base threshold value is advantageously between one time and three times an idling power consumption or idling energy consumption of the motor.

The base threshold value and/or the upper threshold value are/is advantageously predefined. As a result, the method can be formulated in a particularly simple manner.

As an alternative, the base threshold value and/or the upper threshold value are/is advantageously changed as a function of a coolant flow which is routed or directed through the instrument. Provision may be made, in particular, for the base threshold value and/or the upper threshold value to be increased when the coolant flow which is directed though the instrument begins or increases.

The base threshold value is advantageously reduced during the integration period over which integration is performed in step (b). The risk of an unnecessary automatic reduction of a start phase or first phase of the integration period is reduced or avoided in this way.

A second aspect of the invention makes provision for a method for operating a medical, in particular dental, handpiece, with the handpiece having a motor for driving a tool. The method comprises the following steps: (a) detection of a time interval, and (c) automatic reduction of a power or energy which is supplied to the motor, if the time interval which is detected in step (a) exceeds a time interval threshold value.

In this case, the time interval advantageously begins when the motor is started.

In this case, successive values of a physical variable are advantageously also detected, this physical variable representing—at least approximately—the power or energy which is supplied to the motor, with the beginning of the time interval being set as a function of the change, with respect to time, in the detected values.

A third aspect of the invention makes provision for a system for operating a medical, in particular dental, handpiece, with the handpiece having a motor for driving a tool. In particular, the system is intended to carry out a method according to the invention as per the aspect of the invention mentioned in the first instance. The system accordingly comprises detection means for the successive detection of values of a physical variable which represents—at least approximately—the power or energy which is supplied to the motor, and also integration means for the formation of an integration value by integrating the values which are detected by the detection means. The system also comprises reduction means for the automatic reduction of a power or energy which is supplied to the motor, if the integration value which is formed by the integration means exceeds a predefined upper threshold value.

A fourth aspect of the invention makes provision for a system for operating a medical, in particular dental, handpiece, with the handpiece having a motor for driving a tool. In particular, the system is intended to carry out a method according to the invention as per the second aspect of the invention. The system accordingly comprises detection means for the detection of a time interval, and also reduction means for the automatic reduction of a power or energy which is supplied to the motor, if the time interval detected by the detection means exceeds a time interval threshold value.

The invention will be explained in greater detail in the text which follows on the basis of exemplary embodiments and with reference to the drawings, in which:

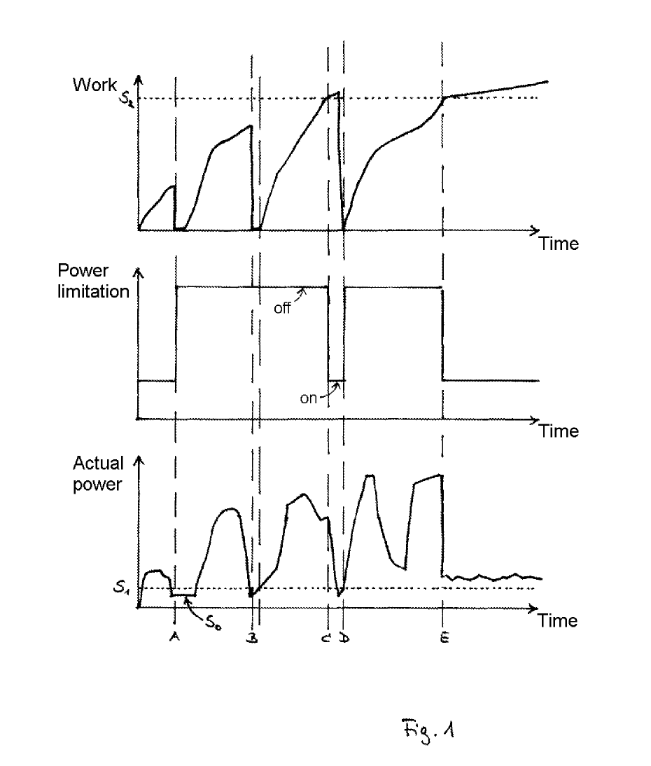

FIG. 1 shows three graphs illustrating an exemplary sequence in the case of a method according to the invention, and

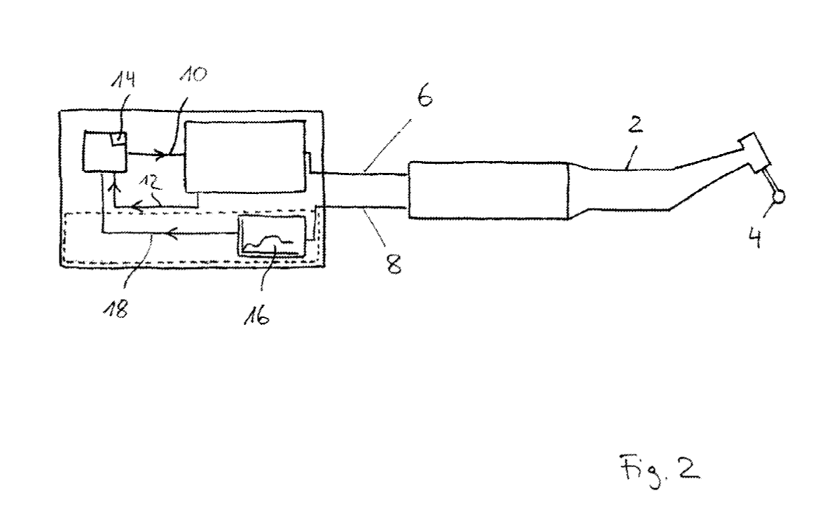

FIG. 2 shows a sketch of a system according to the invention.

FIG. 1 shows three graphs illustrating an exemplary sequence in the case of a method according to the invention for operating a dental handpiece.

The term “handpiece” is intended to identify an instrument which is provided or suitable for medical, in particular dental, work and which is intended to be held in a hand of a user while he is performing the work. The handpiece may be, for example, a so-called angle piece.

The handpiece has a motor for driving a tool. The motor may be, in particular, an electric motor. The tool may be, for example, a drill or grinding tool.

The work performed by the tool, or a variable which approximately represents the work, is plotted against time in the graph shown at the top in FIG. 1. Power limitation for the motor is plotted against time in the graph in the middle, and an “actual power” which is supplied to the motor is plotted against time in the graph at the bottom. The time axes have an identical scale and an identical orientation for all three graphs. Selected times A, B, C, D and E are indicated in the graph at the bottom, these times correspondingly also applying to the graphs at the top and in the middle, as is indicated by interrupted vertical lines.

In a step (a) of the method according to the invention, values of a physical variable are detected in succession, with the physical variable representing—at least approximately—the power or energy which is supplied to the motor. The physical variable may be, for example, the power or energy which is supplied to the motor itself.

The values can be detected virtually continuously in step (a). Therefore, provision may be made for the power, that is to say the motor power, to be sampled. Provision may be made, in particular, for the detection to be performed in a period between starting and stopping of the motor, also referred to as the “treatment period” in the text which follows. In the exemplary sequence which is shown in FIG. 1, a curve which is formed by the detected values is sketched in the graph at the bottom. For simplicity, the ordinate is labeled with the term “Actual power”.

In a further step (b), an integration value is formed by integration, with respect to time, of the values which are detected in step (a). In this case, provision may be made for a plurality of integration values to be formed in succession, that is to say a series of integration values is formed, and therefore a time profile of the integration values is obtained. In the exemplary sequence which is shown in FIG. 1, the time profile of these integration values is sketched in the graph at the top. Since the physical variable represents the power or energy which is supplied to the motor, the integration value which is formed in this way is a measure of the work which is performed by the tool. Therefore, for simplicity, the ordinate of the graph at the top is labeled with the term “Work”.

Provision may be made, in particular, for the integration values to be formed virtually continuously, for example in accordance with the sampling rate at which the values are detected in step (a), and therefore an integration value which is representative of the respective moment is available virtually at any given moment during the treatment period.

In a further step (c), automatic reduction of a power or energy which is supplied to the motor is performed if the integration value which is formed in step (b) exceeds an upper threshold value S₂. In this case, provision may be made, in particular, for the automatic reduction to be performed only if the integration value which is formed in step (b) exceeds the upper threshold value S₂.

In FIG. 1, the upper threshold value S₂ is sketched using a dotted line in the graph at the top. In the example shown, the integration value or the “work” exceeds the threshold value S₂ at time C. As a result, the motor power is automatically reduced, as indicated in a qualitative manner in the curve in the graph at the bottom. If the tool is subject to loading at this moment, there is a resultant drop in the rotation speed of the instrument on account of this reduction of power. A user of the handpiece will therefore relieve the tool of loading in this situation. In the graph in the middle, the terms “off” and “on” indicate when the corresponding power limitation or “power capping” is cancelled or activated.

For the purpose of effective protection against burning, it is advantageous for the automatic reduction, which is carried out in step (c), in the power or energy which is supplied to the motor to be performed as soon as possible after the time at which the integration value exceeded the upper threshold value S₂. Provision may be made, for example, for the period between the time at which the integration value exceeds the upper threshold value S₂ and the beginning of the reduction which is performed in step (c) to be shorter than a specific small time interval; the short time interval can be, for example, a half or a tenth of a second.

A visual and/or audible signal is advantageously also generated in step (c). A signal of this kind can be used to inform the user of the handpiece that the integration value has exceeded the upper threshold value S₂.

Provision may be made for integration to be performed over an integration period in step (b), with the beginning of the integration period being defined as a function of the change, with respect to time, in the values which are detected in step (a). For example, provision may be made for the integration period to begin when the values which are detected in step (a) go beyond the base threshold value S₁ in the upward direction from below or in the downward direction from above. This is indicated, by way of example, at time D in FIG. 1.

Provision may be made, for example, for the integration period to begin when one of the values which is detected in step (a) is lower than the base threshold value S₁ and the value which was detected immediately prior was higher than the base threshold value S₁, or when one of the values which is detected in step (a) is lower than the base threshold value S₁ and the value which is detected immediately after is higher than the base threshold value S₁.

In this case, the base threshold value S₁ is advantageously selected such that it is somewhat higher than an idling power consumption or idling energy consumption of the motor. For example, the base threshold value (S₁) can be between one time and three times the idling power consumption or idling energy consumption of the motor. In FIG. 1, the actual power at time A corresponds to the idling power consumption or idling energy consumption of the motor. This actual power is denoted S₀ in the graph at the bottom.

For the time interval between times A and B, FIG. 1 outlines a situation in which the motor is operated by a user in such a way that the actual power initially rises and then falls below the base threshold value S₁ again, before the work or the integration value exceeds the upper threshold value S₂. Therefore, in this case, the power which is supplied to the motor is not automatically reduced in accordance with the method according to the invention. In this case, the detected values lead to the conclusion that there is a high probability that the temperature of the instrument in this time interval is not so high that possible damage would be expected.

If, after automatic reduction in step (c), the actual power does not fall below the base threshold value S₁, this indicates that the handpiece is probably damaged, for example has experienced cage fracture. The actual power then remains limited, as indicated in FIG. 1, by way of example, after time E.

Provision may be made for the base threshold value S₁ and/or the upper threshold value S₂ to be predefined.

However, as an alternative, provision may also be made for the base threshold value S₁ and/or the upper threshold value S₂ to be changed during the integration period, in particular to be adjusted as a function of a further factor. Provision may be made, for example, for the base threshold value S₁ and/or the upper threshold value S₂ to be changed as a function of a coolant flow which is directed or routed through the instrument. In particular, provision may be made for the base threshold value S₁ and/or the upper threshold value S₂ to be increased when the coolant flow starts or increases and/or for the base threshold value S₁ and/or the upper threshold value S₁ to be reduced when the coolant flow decreases or ends. The coolant may be, for example, spray water.

A considerable portion of the heat which is produced in the instrument can be transported away by a coolant of this kind. Provision may be made for the coolant flow to be detected by a flow meter and then—as described above—for the base threshold value S₁ and/or the upper threshold value S₂ to be changed or adjusted as a function of the detected coolant flow.

The described change in or adjustment of the base threshold value S₁ and/or the upper threshold value S₂ can reduce the risk of automatic reduction of the supplied power or energy being triggered in step (c) even though the current temperature of the instrument does not require this reduction. It is even possible to set the threshold values such that almost 100% protection against burning is ensured since the “heat-generating power” is “transported away” by the coolant.

Provision may also be made for the base threshold value S₁ to be reduced during the integration period over which integration is performed in step (b). This can be provided, in particular, in a first phase or in a start phase of the integration period. This can reduce the risk of automatic reduction of the supplied power or energy being triggered in a phase such as this in step (c) even though the current temperature of the instrument does not require this reduction.

In the first exemplary embodiment described above, values of a physical variable are used as an indication of heat development in the instrument. As an alternative to the detection of values of this kind, a time interval can be detected in accordance with a second exemplary embodiment, with an automatic reduction of power or energy supplied to the motor being performed if the detected time interval exceeds a time interval threshold value. This is structurally simpler than in the first exemplary embodiment, but the level of accuracy that can be achieved is generally lower in this case.

In this case, provision may be made for the time interval to begin when the motor is started.

As an alternative, provision may be made for the beginning of the time interval to be the same as the beginning of the integration period in the first exemplary embodiment. Therefore, provision may be made, in particular, for successive values of a physical variable also to be detected, this variable representing—at least approximately—the power or energy supplied to the motor, with the beginning of the time interval being defined as a function of the change, with respect to time, in the detected values. Therefore, provision may be made, for example, for the time interval to begin when the actual power exceeds the base threshold value.

In other respects, the descriptions of the first exemplary embodiment analogously apply to the second exemplary embodiment too. In this case, the integration period in the first exemplary embodiment corresponds to the time interval in the second exemplary embodiment, and the upper threshold value S₂ in the first exemplary embodiment corresponds to the time interval threshold value in the second exemplary embodiment.

A sketch of an exemplary embodiment of a system according to the invention for carrying out a method according to the invention as per the above-described first exemplary embodiment is illustrated in FIG. 2. The system is suitable for operating a dental handpiece 2, with the handpiece 2 having a motor for driving a tool 4. The system accordingly comprises detection means for the successive detection of values of a physical variable which represents—at least approximately—the power or energy which is supplied to the motor. The system also comprises integration means for the formation of an integration value by integrating the values which are detected by the detection means, and also reduction means for the automatic reduction of a power or energy which is supplied to the motor, if the integration value which is formed by the integration means exceeds a predefined upper threshold value.

In accordance with the above description of the first exemplary embodiment, the system can also comprise means for generating a visual and/or audible signal, which means can generate the signal in the situation in which the integration value which is formed by the integration means exceeds a predefined upper threshold value.

Furthermore, the system can accordingly comprise means for the storage of and/or for changing the upper threshold value or the base threshold value, and also means for the generation of a coolant flow which is directed or routed through the instrument.

In this case, the said means are preferably each designed to implement the function which is intended in accordance with the method described above.

FIG. 2 also diagrammatically indicates the electrical energy supply 6 and—as an optional component—the spray water supply 8, and furthermore the control of the power output 10 and the power measurement 12 and also the algorithm design 14 (analog or digital). A flow rate meter 16 for a coolant is also optionally provided; reference symbol 18 indicates the quantity of coolant or spray water 18.

A corresponding system for carrying out a method according to the invention as per the above-described second exemplary embodiment accordingly comprises detection means for the detection of a time interval, and reduction means for the automatic reduction of a power or energy which is supplied to the motor, if the time interval which is detected by the detection means exceeds a time interval threshold value. The statements made in relation to the first-mentioned system apply in an analogous manner in other respects.

1. A method for operating a medical handpiece, with the handpiece having a motor for driving a tool, comprising:
(a) successively detecting values of a physical variable which represents power or energy supplied to the motor,
(b) forming an integration value by integrating the values detected in (a), and
(c) automatically reducing a power or energy supplied to the motor, if the integration value which is formed in (b) exceeds an upper threshold value.

2. The method as claimed in claim 1, wherein the physical variable is the power or energy supplied to the motor.

3. The method as claimed in claim 1, comprising also generating a visual and/or audible signal in (c).

4. The method as claimed in claim 1, comprising performing integration over an integration period in (b), with the beginning of the integration period being defined as a function of the change, with respect to time, in the values detected in (a).

5. The method as claimed in claim 4, wherein the integration period begins when one of the values detected in (a) is lower than a base threshold value and the value detected immediately prior was higher than the base threshold value, or when one of the values detected in (a) is lower than the base threshold value and the value detected immediately after is higher than the base threshold value.

6. The method as claimed in claim 5, wherein the base threshold value is between one time and three times an idling power consumption or idling energy consumption of the motor.

7. The method as claimed in claim 5, wherein at least one of the base threshold value and the upper threshold value is predefined.

8. The method as claimed in claim 5, comprising changing at least one of the base threshold value and the upper threshold value as a function of a coolant flow directed through the instrument.

9. The method as claimed in claim 5, comprising reducing the base threshold value during the integration period over which integration is performed in (b).

10. A method for operating a medical handpiece, with the handpiece having a motor for driving a tool, comprising:
(a) detecting a time interval, and
(c) automatically reducing a power or energy supplied to the motor, if the time interval detected in (a) exceeds a time interval threshold value.

11. The method as claimed in claim 10, wherein the time interval begins when the motor is started.

12. The method as claimed in claim 10, comprising also detecting successive values of a physical variable, the physical variable representing power or energy supplied to the motor, with the beginning of the time interval being defined as a function of the change, with respect to time, in the detected values.

13. A system for operating a medical handpiece, with the handpiece having a motor for driving a tool, comprising
detection means for successively detecting values of a physical variable which represents power or energy supplied to the motor,
integration means for forming an integration value by integrating the values detected by the detection means, and
reduction means for automatically reducing a power or energy supplied to the motor, if the integration value formed by the integration means exceeds a predefined upper threshold value.

14. A system for operating a medical handpiece, with the handpiece having a motor for driving a tool, comprising
detection means for detecting a time interval, and
reduction means for automatically reducing a power or energy supplied to the motor, if the time interval detected by the detection means exceeds a time interval threshold value.
